(19) United States
(12) Patent Application Publication
(10) Pub. No.: US 2022/0138538 A1
(43) Pub. Date: May 5, 2022

(54) Maximum Entropy Boltzmann Machines

(71) Applicant: Nell Watson Ltd, Worcestershire (GB)

(72) Inventors: Roshawn Marcell Valentino TERRELL, Austin, TX (US); Timofey GOLUBEV, Hancock, MI (US); Eleanor Adele WATSON, Carrickfergus (GB)

(73) Assignee: Nell Watson Ltd, Worcestershire (GB)

(21) Appl. No.: 17/513,012

(22) Filed: Oct. 28, 2021

Related U.S. Application Data
(60) Provisional application No. 63/107,144, filed on Oct. 29, 2020.

(51) Int. Cl. G06N 3/04; G06N 3/08

(52) U.S. Cl. CPC G06N 3/0472; G06N 3/08

(57) ABSTRACT

This specification describes machine-learning systems and methods for modelling physical and/or biological systems that apply the principle of maximum entropy to restricted Boltzmann machines. According to a first aspect of this specification, there is described a method for modelling a complex system using machine learning. The method includes: obtaining training data representing the complex system; determining one or more parameters of a parametrised physical model representing the complex system using the training data; and predicting one or more properties of the complex system and/or behaviour of the complex system from the parametrised physical model. Determining parameters of the parametrised physical model representing the complex system using the training data includes: mapping the parametrised physical model to a restricted Boltzmann machine; training the restricted Boltzmann machine on the training data representing the complex system using a maximum entropy principle; and extracting the one or more parameters of the parametrised physical model from the trained restricted Boltzmann machine.

### CROSS-REFERENCE TO RELATED APPLICATION

This application claims the benefit of priority to U.S. Provisional Application Ser. No. 63/107,144, filed on Oct. 29, 2020, the entirety of which is herein incorporated by reference.

### FIELD

This specification describes machine-learning systems and methods for modelling physical and/or biological systems that apply the principle of maximum entropy to restricted Boltzmann machines.

### BACKGROUND

Modelling complex interacting systems, such as those that occur in biology, physics and finance, is a challenging task. There is a long history of attempting to simplify this modelling by using simplified physical models taken from other contexts, such as the Ising model or Bose-Hubbard model, to represent these systems. These models are typically defined by a Hamiltonian/energy function that includes a number of parameters that define the model (e.g. coupling contestants, interaction strengths or the like).

Determining values of these parameters that will result in a model that accurately represents some aspect of the complex system being modelled is a not a trivial task. Current methods often rely on crude approximations or best guesses at parameter values that will adequately represent the system of interest.

### SUMMARY

This specification describes techniques for modelling complex systems using restricted Boltzmann machines.

According to a first aspect of this specification, there is described a method for modelling a complex system using machine learning. The method comprises: obtaining training data representing the complex system; determining one or more parameters of a parametrised physical model representing the complex system using the training data; and predicting one or more properties of the complex system and/or behaviour of the complex system from the parametrised physical model. Determining parameters of the parametrised physical model representing the complex system using the training data comprises: mapping the parametrised physical model to a restricted Boltzmann machine; training the restricted Boltzmann machine on the training data representing the complex system using a maximum entropy principle; and extracting the one or more parameters of the parametrised physical model from the trained restricted Boltzmann machine.

According to a further aspect of this specification, there is described a non-transitory, computer readable medium containing instructions that, when executed by a computer, cause the computer to perform a method for modelling a complex system using machine learning, the method comprising: obtaining training data representing the complex system; determining one or more parameters of a parametrised physical model representing the complex system using the training data; and predicting one or more properties of the complex system and/or behaviour of the complex system from the parametrised physical model. Determining parameters of the parametrised physical model representing the complex system using the training data comprises: mapping the parametrised physical model to a restricted Boltzmann machine; training the restricted Boltzmann machine on the training data representing the complex system using a maximum entropy principle; and extracting the one or more parameters of the parametrised physical model from the trained restricted Boltzmann machine.

According to a further aspect of this specification, there is described a system comprising one or more processors and a memory, the memory containing computer-readable instructions that, when executed by the one or more processors, causes the system to perform a method for modelling a complex system using machine learning, the method comprising: obtaining training data representing the complex system; determining one or more parameters of a parametrised physical model representing the complex system using the training data; and predicting one or more properties of the complex system and/or behaviour of the complex system from the parametrised physical model. Determining parameters of the parametrised physical model representing the complex system using the training data comprises: mapping the parametrised physical model to a restricted Boltzmann machine; training the restricted Boltzmann machine on the training data representing the complex system using a maximum entropy principle; and extracting the one or more parameters of the parametrised physical model from the trained restricted Boltzmann machine.

The method, computer readable medium and/or system may include one or more of the following aspects, either alone or in combination.

Training the restricted Boltzmann machine on the training data representing the complex system may comprise applying an optimisation procedure to an objective function comprising an entropy-based term. The entropy-based term may comprise a Shannon entropy. The entropy-based term may comprise an average linear entropy, and wherein the optimisation procedure comprises the use of an artificial bee colony method, a pattern search method and/or a gradient search optimisation method.

The parametrised physical model may be an Ising model. The parameters may comprise one or more pairwise couplings and/or one or more external field parameters. Determining one or more properties of the complex system from the parametrised model may comprise determining a magnetisation and/or susceptibility of the Ising model.

The parametrised physical model may be a Bose-Hubbard model. The parameters may comprise one or more nearest-neighbour hopping amplitudes, an on-site interaction strength and/or a chemical potential. Determining one or more properties of the complex system from the parametrised model may comprise determining a critical temperature from the Bose-Hubbard model.

The complex system comprises a physical or biological system.

The subject matter described in this specification can be implemented in particular ways so as to realize one or more of the following advantages. The methods described herein can be used to determine parameters of physical models modelling complex systems in a computationally efficient manner, obtaining favourable results with small RBMs using the maximum entropy approach when compared with the typical results achieved when solving physical models through other more complicated methods. This can result in a reduction in the amount of computational resources (e.g. memory, processing power) used to model complex physical systems.

### BRIEF DESCRIPTION OF THE DRAWINGS

FIG. 1 shows a schematic overview of a method for modelling a complex system using machine learning.

FIG. 2 shows an example of a system of spins described by an Ising model;

FIG. 3 shows an example plot of the entropy of a hard-core Bose-Hubbard model;

FIG. 4 shows a flow diagram of an example method for modelling a complex system using machine learning;

FIG. 5 shows a flow diagram of an example method for determining one or more parameters of a parametrised physical model representing the complex system; and

FIG. 6 shows a schematic overview of a computing system/apparatus for performing any of the methods described herein.

### DETAILED DESCRIPTION

This application describes systems and methods that determine model parameters for a parametrised physical model of a complex system by mapping the parameterised physical model to a restricted Boltzmann machine, training the Boltzmann machine (RBM) on data representing the system being modelled using machine learning methods, and extracting the parameters of the model from the trained RBM. The extracted parameters can then be used to predict properties of the complex system and/or the behaviour of the complex system. In some embodiments, the extracted parameters may be used to modify properties of the system in order to drive the complex system into a desirable state.

Taking in the general method of maximum entropy as the optimization function of neural networks, a Restricted Boltzmann Machine corresponding to a real physical system can be constructed. The optimization problem provided using known methods for RBM will give us the optimal parameters for its different possible physical representations of the complex system.

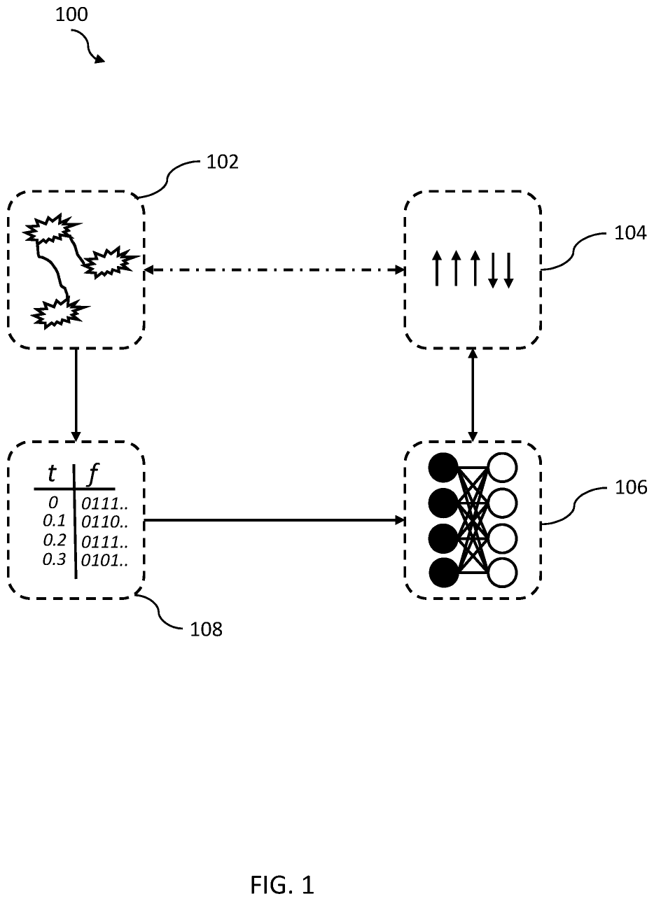

An example of such a method 100 is shown in FIG. 1.

The complex system 102 may comprise a complex physical system, such as system of interacting particles. The complex system 102 may be a biological system, such as a system of biological neurons interacting with each other, as shown in FIG. 1. The complex system 102 may be an economic system, a sociological system or an ethical system. In general, the complex system 102 may be a system in which multiple agents/components interact with each other in complex ways.

As part of the method, a parameterised physical model 104 is chosen as a simplified model for modelling/representing one or more aspects of the complex system. The parametrised physical model 104 is typically a “toy” model of a physical system that captures some essential physical processes/behaviours of the system in a simplified way. The parametrised physical model 104 may be defined by a Hamiltonian or Energy function that comprises a plurality of parameters that, for example, represent couplings and/or interactions between constituents of the system and a plurality of variables that, for example, represent the degrees of freedom of the system. The parametrised physical model 104 may model a system with discrete states, for example, occupation numbers of sites on a lattice, or spin values. Properties/behaviour of the complex system 102 being modelled can be mapped to thermodynamic properties/behaviour of the parametrised model 104, such as a magnetisation or susceptibility, allowing them to be derived/predicted from the parametrised physical model.

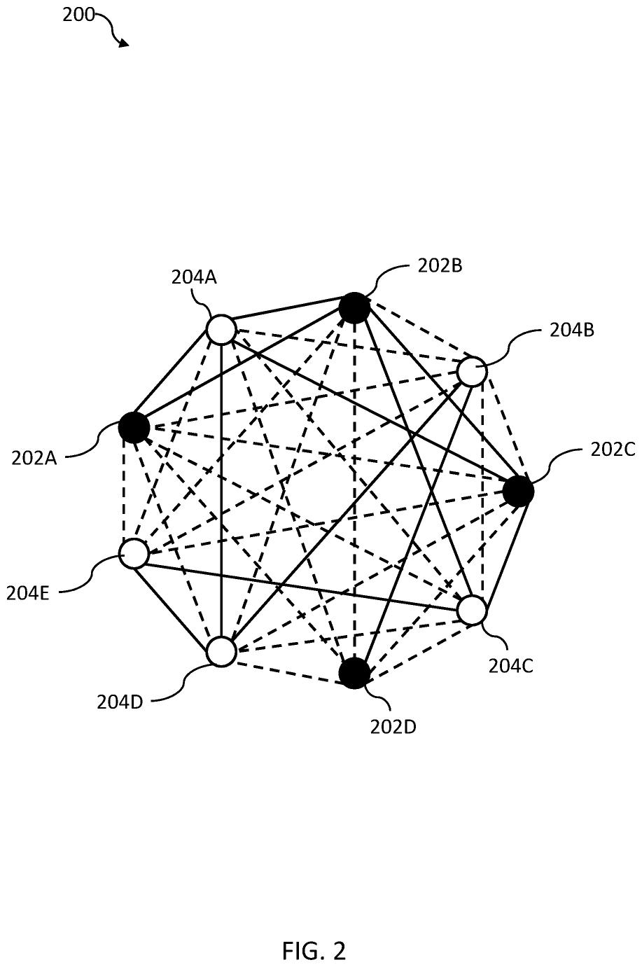

An example of such a parametrised physical model 104 is the Ising model, as shown in FIG. 2, which models a lattice/graph of spins, σᵢ, in one, two, three or more dimensions that can be in one of two states (either + or −) that each interact with their adjacent neighbours and an external field. The Ising model is defined by the interactions between neighbouring spins, Jᵢⱼ, and the interactions between the spins and the external field, hᵢ. Despite its simplicity, the Ising model has been used successfully to model many other complex systems, ranging from biological neurons to traffic light behaviour. Examples of mapping the Ising model to a RBM are described with reference to FIG. 2.

Another example of such a parametrised physical system 104 is the Bose-Hubbard model. The Bose-Hubbard model models a lattice of Bosons, bᵢ, which only interact with other Bosons occupying the same lattice site as themselves. The model is parametrised by tunneling parameters, Jᵢⱼ, representing the hopping of Bosons between lattice sites, an on-site interaction strength, U, and a chemical potential, μ, for the system.

Many other examples of parametrised physical models 104 are possible, and include (but are not limited to): the Kondo model; the Anderson model; the Heisenberg model; the Potts model; or the XY model.

The chosen method is mapped to a RBM 106. A RBM 106 is a type of artificial neural network that can learn a probability distribution over a set of inputs, and comprises a plurality of nodes in two layers: a visible layer and a hidden layer. Nodes in the first (visible) layer are connected to nodes of the second (hidden) layer, and there are no direct connections between nodes in the same layer (i.e., hidden-hidden and visible-visible connections are not used). Each node is associated with a bias (denoted aᵢ for visible nodes and bᵢ for hidden nodes), and each connection between two nodes (labelled land J) is associated with a weight, wᵢⱼ. In general, each node in the visible layer may connected to any one or more of the nodes in the hidden layer. In some implementations, each visible node is connected to every hidden node. Setting a weight between two nodes to zero effectively disconnects them. In the example shown, the RBM 106 has four visible nodes and four hidden nodes, though other numbers of nodes may in general be used.

An RBM is mathematically defined by a Hamiltonian that has the form:

$$E ( v , h ) = {\sum }_{i = 1}^{n} {a}_{i} {v}_{i} + {\sum }_{j = 1}^{m} {b}_{j} {h}_{j} + {\sum }_{i , j} {W}_{i j} {v}_{i} {h}_{j}$$

where a and b are the bias offsets of the visible (v) and hidden (h) units respectively and W is the weight matrix that together define the RBM architecture. The components of the weight matrix define the strength of the connections between corresponding hidden and visible units.

While the methods described herein are described in relation to restricted Boltzmann machines, it will be apparent to the person skilled in the art that the methods described herein can equally be applied to other types of Boltzmann machine, i.e. where the restrictions of no connections between visible units and no connections between hidden units have been removed.

As part of the method, variables of the parametrised physical model 104 (e.g. spins, bosonic fields etc.) are mapped to variables of the RBM 106 (the hidden or visible states of the nodes of the RBM). The parameters of the model (e.g. coupling constants, interaction, hopping terms etc.) are mapped to parameters of the RBM (the weights, wᵢⱼ, and biases aᵢ and bᵢ of the RBM). Examples of such mappings are provided below.

As part of the method, training data 108 representing the complex system being modelled is obtained. The training data 108 comprises data collected from the complex system, and may comprise labelled training data and/or unlabelled training data. For example, when modelling a two-dimensional spin system, the training data 108 may be binary spin configurations, such as those generated by a Monte-Carlo simulation. As another example, when modelling a biological system of neurons, the training data 108 may comprise a response pattern of the neurons over time, which may be encoded as a binary pattern (e.g. “on” and “off” state). An example of such data can be found in Schneidman, M. Berry, R. Segev, W. Bialek. Nature 440, 1007-1012 (2006), the contents of which are incorporated herein by reference. Many other examples will be apparent to the person skilled in the art.

The training data 108 is used to train the RBM 106 using a maximum entropy principle. Training the RBM 106 involves varying the parameters of the RBM 106 according to some training procedure in order to achieve a training goal, e.g. maximising an entropy function. An optimisation procedure may be applied to train the RBM 106 using a loss/objective function that comprises an entropy-like term. The objective/loss function may comprise a Shannon entropy term and/or an average linear entropy. The optimisation procedure may comprise the use of stochastic gradient descent, an artificial bee colony method, a pattern search method and/or a gradient search optimisation method.

The training may continue until a threshold condition is satisfied, such as a threshold number of training epochs and/or a convergence criterion.

Examples of methods of training a RBM 106 are described in “A Practical Guide to Training Restricted Boltzmann Machines” (G. E. Hinton, 2012, https://doi.org/10.1007/978-3-642-35289-8_32), the contents of which are incorporated herein by reference. Further examples of training a RBM can be found in “Quantum Codes from Neural Networks” (J. Bausch and F. Leditzky, arXiv:1806.08781v2), the contents of which are hereby incorporated by reference, in particular in Appendix G.

Once trained, the trained values of the parameters of the RBM 106 are extracted, and the corresponding parameters of the parametrised physical model 104 are determined from them. The inverse mapping to the mapping of the parametrised physical model 104 to the RBM 106 may be applied to determine the parameters of the parametrised physical model 104.

Once the parameters of the parametrised physical model 104 have been determined, the parametrised physical model 104 is used to determine one or more properties of the complex system 102 and/or model the behaviour of the complex system 102. Properties of the parametrised physical model 104 (e.g. magnetisation, susceptibility, critical temperatures etc.) may correspond, or be analogous to, properties of the complex system 102. For example, if modelling a system of biological neurons, the magnetisation is analogous to the standard deviation of neuron firing thresholds across a neural population and the susceptibility is analogous to the difference in slope of the neural response functions. The susceptibility in general describes a sensitivity of the system to external perturbations. Many other examples will be apparent to the skilled person.

Alternatively or additionally, the extracted parameters can be used to determine modifications to the complex system 102 being modelled that may be required to drive/steer the system into some desirable state, e.g. a maximum entropy state, a maximum freedom state or the like. Such modifications may contribute towards a Solomonoff Induction/AIXI intelligence algorithm in which a total reward from a reinforcement-learning environment is maximised.

The methods described herein may be applied to an Ising model. An Ising model is a model that describes a system of spins in terms of their pairwise interactions. In terms of biological neurons, the spin can be re-interpreted as the “on” or “off” state of neurons where the “on” state is when the neuron is emitting an action potential (e.g. electrochemical pulse). The Ising model has been used to model many real-world systems.

FIG. 2 shows an example of a fully connected, pairwise Ising model 200. In this example, the model has nine spins 202A-D, 204A-E, though it will be appreciated that other numbers of spins may alternatively be used. For example, 4, 6, 8 or more spins may be used. The spins 202A-D, 204A-E can have values +1 (e.g. for spins 202A-D) or −1 (e.g. for spins 204A-E), and each interact with every other spin in the system. Solid lines indicate a negative valued interaction, while dashed lines indicate a positive valued interaction. The spin configuration and interaction signs in FIG. 2 are shown as an example only, and are not intended to be limiting.

A RBM can be mapped to such an Ising model, and vice-versa, in the following way.

As discussed above, an energy associated with a RBM with n visible units, v, and m hidden units, h, can be written in the form:

$$E ( v , h ) = {\sum }_{i = 1}^{n} {a}_{i} {v}_{i} + {\sum }_{j = 1}^{m} {b}_{j} {h}_{j} + {\sum }_{i , j} {W}_{i j} {v}_{i} {h}_{j}$$

where a and b are the bias offsets of the visible and hidden units respectively and W is the weight matrix. This relation is very similar to the description of the Ising model if it is assumed that the visible and hidden units are equivalent (i.e. vᵢ=hᵢ=σᵢ). Taking the opposite sign of the weights, the energy can be re-written as:

$$E ( s ) = - {\sum }_{i = 1}^{N} {a}_{i}^{′} {σ}_{i} - {\sum }_{i j} {W}_{i j}^{′} {σ}_{i} {σ}_{j}$$

This is in the form of an Ising model, where the spins σ (valued +1 or −1) are used to represent the visible and hidden units, a′ represents a “magnetic field” (usually denoted h in the canonical form of the Ising model) and W′ represents pairwise “spin-spin interactions” (usually denoted J in the canonical form of the Ising model).

During training, RBMs use the principle of maximum entropy (e.g. a search for the minimum of a cost function which is minus entropy) to the find an optimal (or approximately optimal) set of coefficients aᵢ, bⱼ, Wᵢⱼ for the model that fit the training data supplied to it. Inversed Ising problem uses the principle of maximum entropy to find the find the optimal set of magnetic field hᵢ and interaction Jᵢⱼ. These models are identical when possible values of hidden/visible units in RBM are considered as values of spins in the inverse Ising problem, which should be equal to +1 or −1.

In the maximum entropy method, a Shannon entropy is defined as:

S[p]=Σp(s)log(p(s))

where, s are possible configurations of system and p(s) are probabilities of these configurations. These configurations could be on-off patterns of firing in neurons or the orientation of spins in a material.

Given observations of a system, the inverse Ising problem seeks to estimate the parameters (h, J) of an Ising model that describes the system. The principle of maximum entropy can be used to solve the inverse Ising model. A more detailed description of maximum entropy usage for solving inverse Ising model using the coniii-3 package is described in “Convenient interface to inverse Ising (ConIII): A Python 3 package for solving Ising-type maximum entropy models” (E. D. Lee et al., Journal of Open Research Software, 7(1).), the contents of which are incorporated herein in their entirety.

Once the parameters of the Ising model have been obtained, they can be used to find thermodynamic variables of the Ising model. An energy function can be built for every possible combination of spins:

$$E ( σ ) = - {\sum }_{i j} {J}_{i j} {σ}_{i} {σ}_{j} - {\sum }_{i} {h}_{i} {σ}_{j} , σ = \{ {σ}_{1} , {σ}_{2} , … , {σ}_{N} \} .$$

From this, a partition function can be calculated by summing over all possible combinations (for N sites there are 2^{N} configurations):

$${Z}_{N} = {\sum }_{σ} exp ( - \frac{E ( σ )}{{k}_{B} T} ) .$$

Here, k_{B} is the Boltzmann constant. A free energy is then given by:

FN=−k_{B}T Ln Z_{N}.

The average of some observable, A, may be determined by applying statistical averaging using:

$$〈 A 〉 = \frac{{\sum }_{σ} A ( σ ) exp ( - \frac{E ( σ )}{{k}_{B} T} )}{{Z}_{N}}$$

For example, for magnetization per site this gives:

$$〈 m 〉 = {\sum }_{σ} \frac{exp ( - \frac{E ( σ )}{{k}_{B} T} )}{{Z}_{N}} {\sum }_{i} {σ}_{i}$$

Furthermore, another fundamental thermodynamic quantity, the Gibbs entropy (S) of the system, can be derived from the free energy (F) and the partition function as follows:

$$S = - \frac{\partial F}{\partial T} = ln ( {Z}_{N} ) + \frac{{k}_{B} T}{{Z}_{N}} \frac{\partial {Z}_{N}}{\partial T} = ln ( {Z}_{N} ) - \frac{1}{{k}_{B} T {Z}_{N}} {\sum }_{σ} E ( σ ) exp ( - \frac{E ( σ )}{{k}_{B} T} ) .$$

When seeking to solve the inverse Ising model problem, the free energy, F, and the entropy, S, can both be used, either alone or in combination, using the maximum entropy hypothesis and/or the minimum energy hypothesis.

The maximum entropy hypothesis states that, in an isolated system, it is a necessary and sufficient condition that for any possible variations in the state of the system, which keeps the energy invariant, the variations of entropy shall either vanish or be negative. The minimum energy hypothesis states that, in an isolated system it is a necessary and sufficient condition that for any possible variations in the state of the system, which do not alter its entropy, the variations of its energy shall either vanish or be positive. Therefore, it is known that in the closed system, as in the Ising model or neuron network, the state with the maximum entropy will correspond to the state of the minimal energy.

RBMs uses the principle of maximum entropy (e.g. a search of minimum of cost function which is the negative of the entropy) to the find an optimal set of coefficients aᵢ, bᵢ, Wᵢⱼ given a set of training data. Inverse Ising problem uses the principle of maximum Entropy to find the find the optimal set of magnetic fields hᵢ and interactions Jᵢⱼ given a set of spin configurations. These models are identical under the above mapping, where possible values of hidden/visible units in RBM are considered as values of spins in the Inversed Ising problem, which should be equal to +1 or −1.

Thus, to solve the inverse Ising model problem, the Ising model is mapped to an RBM, as discussed above. The RBM is then trained on training data comprising a plurality of configurations of the Ising model at each of one or more temperatures, with a training objective of maximising the entropy, using any of the known methods for training RBMs. Once trained, the parameters of the RBM are extracted, and mapped back onto parameters of the Ising model. From these, properties of the system being modelled with the Ising model may be determined. For example, the magnetisation or susceptibility of the Ising model may be determined from the determined parameters of the Ising model. Depending on how the Ising model is being used to represent the complex system being modelled, these properties may be used to infer properties of the complex system.

More generally, the methods described herein can be applied to many parameterised models of systems of interacting particles. Large systems of interacting particles can in general be represented with the real-space Hamiltonian

Hₜₒₜ=H_{sys}(x,λ(t))+H_{bath}(Y)+hᵢₙₜ(x,y)

where x accounts for all the coordinate degrees of freedom for the particles in the system, y does the same for the bath, and the Hamiltonian functions H_{sys}, H_{bath}, and hᵢₙₜ define conservative interactions among the various position coordinates of the system and the bath. The function λ(t) is a time-varying external field that acts exclusively on the system and can do work on the coordinates x. Often, hᵢₙₜ is taken to be small, and may be ignored.

One example of such a system is the Bose-Hubbard model. The Bose-Hubbard model provides a simple description of interacting spinless bosons (particles that obey Bose-Einstein statistics) on a lattice. It is widely used to describe the phase transition to the state of a Bose-Einstein condensate in systems of ultracold bosons in an optical lattice, and may also be used to model the dynamics of firing neurons. The methods described herein can be applied to this model.

The Bose-Hubbard model describes a system of interacting Bosons. The Bose-Hubbard model is described by the Bose-Hubbard Hamiltonian, which is defined on a lattice:

$$H = - {\sum }_{〈 i , j 〉} {t}_{i j} {\hat{b}}_{i}^{†} {\hat{b}}_{j} + {\sum }_{i} \frac{U}{2} ( {\hat{n}}_{i} - 1 ) {\hat{n}}_{i} - {\sum }_{i} μ {\hat{n}}_{i}$$

where \hat{b}ᵢ^{†} is a bosonic creation operator at site i, \hat{b}ⱼ is a bosonic annihilation operator at site j, tᵢⱼ is a nearest neighbour hopping amplitude, \hat{n}ᵢ=\hat{b}ᵢ^{†}\hat{b}ᵢ is the occupation of site i, U is the on-site interaction between two bosons and μ is a chemical potential. For large enough interactions U, the ground state of the system will be a Mott insulating phase while it remains a superfluid for smaller interactions.

In some implementations, the nearest neighbour hopping term may be set equal to a constant, i.e. tᵢⱼ=Jδᵢⱼ, where δᵢⱼ is 1 when there is link between lattice sites i and j and zero otherwise (i.e. is only non-zero between neighbouring lattice sites). Such implementation may be used to model, for example, the dynamics of firing neurons. Similar models have been used to describe the behavior of the system in depend of network topology (see, for example, “Phase diagram of the Bose-Hubbard Model on Complex Networks” A. Halu et al., EPL (Europhysics Letters), 99(1), 18001, (2012), the contents of which are incorporated herein by reference in their entirety) and for networks in machine learning (see, for example, “Identifying quantum phase transitions with adversarial neural networks”, P. Huembeli et al., Phys. Rev. B, 97, 134109, (2018), the contents of which are incorporated herein by reference in their entirety).

A Hubbard-operator (X-operator) approach may be used to re-write the Bose-Hubbard Hamiltonian in different form. The Hubbard operators may be written as an outer product of basis vectors, which in Dirac notation is:

\hat{X}ᵢ^{nm}=|n,i [symbol] [symbol] m,i|

where i labels a lattice site and m and n label quantum states. In this formalism, the creation and annihilation operators can be written in terms of the X-operators as:

$${\hat{b}}_{j} = {\sum }_{n} \sqrt{n + 1} {\hat{X}}_{i}^{n , n + 1} , {\hat{b}}_{i}^{†} = {\sum }_{n} \sqrt{n + 1} {\hat{X}}_{i}^{n + 1 , n}$$

The Bose-Hubbard Hamiltonian can then be reformulated as:

$$\hat{H} = - J {\sum }_{< i , j >} ( {\sum }_{n} \sqrt{n + 1} {\hat{X}}_{i}^{n + 1 , n} ) ( {\sum }_{n} \sqrt{n + 1} {\hat{X}}_{j}^{n , n + 1} ) + {\sum }_{i , n} {α}_{n} {\hat{X}}_{i}^{n n}$$

where n is the number of bosons/neurons on each site land

$${α}_{n} = \frac{U}{2} n ( n - 1 ) - μ n ,$$

are single-site energies. One can write this form of the Bose-Hubbard Hamiltonian in matrix form as Ĥ=ΣᵢĤ_{latt,i} where

$${\hat{H}}_{l a t t , i} = ( \begin{matrix}{α}_{0} & - J & 0 & … & … \\ - J & {α}_{1} & - \sqrt{2} J & 0 & … \\ 0 & - \sqrt{2} J & … & - \sqrt{3} J & … \\ … & … & - \sqrt{3} J & … & … \\ … & … & 0 & … & … \\ … & … & … & - \sqrt{n} J & {α}_{n}\end{matrix} )$$

The possible energies associated with each site are given by the eigenvalues of the Hamiltonian, in other words, the values #k that satisfy Ĥ_{latt,i}|ψ [symbol] =βₖ|ψ [symbol] . Ĥ_{latt,i} is a symmetric tridiagonal matrix and can be diagonalized using standard numerical methods. Diagonalization will result in a matrix of the form

$${\hat{H}}_{latt , i}^{′} = ( \begin{matrix}{β}_{0} & 0 & 0 & 0 \\ 0 & {β}_{1} & 0 & 0 \\ 0 & 0 & … & 0 \\ 0 & 0 & 0 & {β}_{n}\end{matrix} )$$

where the eigenvalues βₖ are functions of αₖ and J, and can be interpreted as energy levels

βₖ=f(αₖ₋₁,αₖ,αₖ₊₁,J)

Here, the dependence is only from α with indices k−1, k, and k+1 because, in general, the matrix Ĥ_{latt,i} is tridiagonal.

In statistical mechanics, the possible states of a system of particles in thermodynamic equilibrium with a heat bath are described by the grand canonical ensemble. The grand canonical ensemble assigns a probability

$${P}_{k} = exp [ \frac{Ω + μ N - {β}_{k}}{{k}_{B} T} ]$$

to each distinct state of the system, where Ω=Ω(μ,V,T) is the grand canonical potential (GCP), N is the number of particles, k_{B} is Boltzmann's constant, and T is temperature. Many important ensemble average quantities, including entropy, can be calculated from the derivatives of the GCP, which is defined as

$$Ω = {k}_{b} T ln ( {\sum }_{k} exp ( - \frac{{β}_{k}}{{k}_{B} T} ) )$$

Entropy can be calculated from the derivative of the GCP with respect to temperature (T) as follows

$$S = - \frac{\partial Ω}{\partial T} = - {k}_{B} ln ( {\sum }_{k} exp ( - \frac{{β}_{k}}{{k}_{B} T} ) ) + {k}_{B} T \frac{1}{( {\sum }_{k} exp ( - \frac{{β}_{k}}{{k}_{B} T} ) )} ( {\sum }_{k} exp ( - \frac{{β}_{k}}{{k}_{B} T} ) ( \frac{{β}_{k}}{{k}_{B} {T}^{2}} ) )$$

In the special case of hard core Bosons, in which, for the Bose-Hubbard model, the only possible states are those where the number of bosons on each site is either 0 or 1, there are only two possible energy eigenvalues for each site, reducing the Hamiltonian Ĥ_{latt,i} to a 2×2 matrix

$${\hat{H}}_{l att , i} = ( \begin{matrix}{α}_{0} & - J \\ - J & {α}_{1}\end{matrix} ) = ( \begin{matrix}0 & - J \\ - J & - μ\end{matrix} )$$

where the values of α₀ and α₁ have been substituted from the above definitions. The energy eigenvalues (βₖ) of this Hamiltonian are

$${β}_{0} = - \frac{μ}{2} - \sqrt{\frac{{μ}^{2}}{4} + {J}^{2}}$$

$$and$$

$${β}_{1} = - \frac{μ}{2} + \sqrt{\frac{{μ}^{2}}{4} + {J}^{2}}$$

The entropy may be found by evaluating S with the sums taken from k=0 to k=1 and substituting these values for βₖ. The entropy is now expressed as a function of the model parameters S=Φ(T,μ,J).

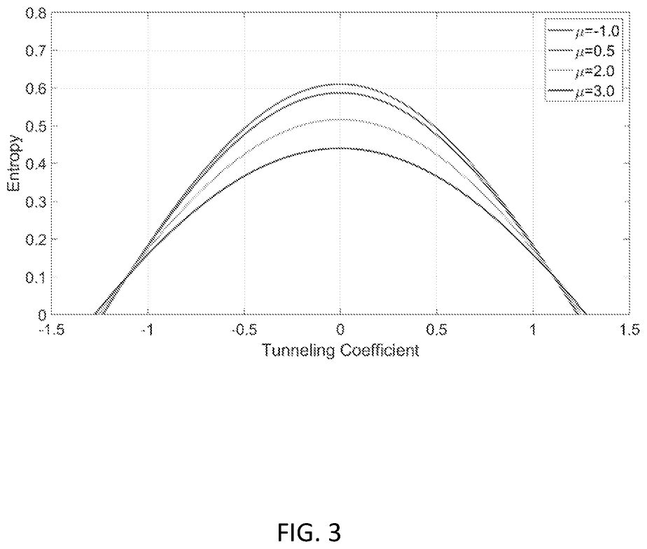

FIG. 3 shows Entropy of the Bose-Hubbard model under the hard-core bosons approximation as a function of tunneling coefficient, J, for different values of chemical potential μ. In this example, the entropy is always maximized when the tunneling coefficient is zero. However, in cases beyond the hard-core bosons approximation, where the number of bosons on a site can be more than one, the entropy will have dependence on one more important parameter, U, which describes the on-site interaction of the bosons, and the behavior of the entropy function will be more complex, and in general there will be non-trivial solutions for the tunneling coefficient and on-site interactions that maximize the entropy.

The numerical construction of an artificial neural network (ANN) for the Bose-Hubbard model may be based on the work of Bausch and Leditzky, who used neural networks to represent Absolutely Maximally Entangled (AME) quantum states (see, for example, “Quantum codes from neural networks”, 21. Bausch, J. and Leditzky, F., New Journal of Physics 2020, 22, 023005, DOI: 10.1088/1367-2630/ab6cdd, the contents of which are incorporated herein in their entirety). Bausch and Leditzky formulated an optimization problem for AME states for dimension d and number of qubits n as follows. An AME state is defined as |ψ_{n,d} [symbol] and can be expressed as a decomposition with respect to a known basis set {|i [symbol] }ᵢ₌₀^{d-1} as

$$\vert {ψ}_{n , d} 〉 = \frac{1}{C} {\sum }_{{i}^{n} ∈ {[ d ]}_{0}^{n}} ψ ( {i}^{n} ) \vert {i}^{n} 〉$$

where C is a normalization constant and the amplitude function ψ(iⁿ) is computed by the neural network. The basis strings are the visible and hidden units from the RBM and also known as the spin-list, which is some space of variables that are encoded for use in the neural network. Different approaches may be used to encode the stings, e.g. binary, scaled or one-hot encodings.

The RBM Hamiltonian has a similar form to the Bose-Hubbard Hamiltonian: the Σ_{k,j}Wₖₗvₗhₖ term from the RBM corresponds to the hopping term-JΣ_{<i,j>}\hat{b}ᵢ^{†}\hat{b}ⱼ in the Bose-Hubbard and Σbₖhₖ corresponds to the on-site energy term

$${\sum }_{i} \frac{U}{2} ( {n}_{i} - 1 ) {n}_{i} - {\sum }_{i} μ {n}_{i} .$$

Note that the visible units term of the RBM, Σₗαₗvₗ, does not have corresponding term in the Bose-Hubbard Hamiltonian. One could interpret the lack of this term as the effect of assuming that the visible and hidden units of the RBM are equivalent. In this way, the relationship between the RBM and Bose-Hubbard Hamiltonian is similar to that between the RBM and Ising Hamiltonian, which also assumes equal visible and hidden units. The similarity between the Bose-Hubbard and RBM Hamiltonians, allow the extension of the ANN developed by Bausch and Leditzky.

The wavefunctions for the Hamiltonian in the hard-core bosons approximation can be written in terms of AME states with d=2 as

$$\vert {ψ}_{n , 2} 〉 = {\sum }_{{i}^{n} ∈ {[ 0 , 1 ]}^{n}} {ψ}_{n} ( {i}^{n} ) \vert {i}^{n} 〉 \qquad$$

where |iⁿ [symbol] =|i [symbol] ⊗|i₂ [symbol] ⊗|i₃ [symbol] ⊗ . . . is the spin list (⊗ denotes a tensor product). Then, the wavefunctions for the RBM can be written as

$$\vert {ψ}_{R B M} 〉 = \vert {ψ}_{n , 2} 〉 = {\sum }_{{i}^{n} ∈ {[ 0 , 1 ]}^{n}} {\sum }_{{h}^{n} ∈ \{ 0 , 1 \}} \frac{exp ( - E ( {i}^{n} , {h}^{n} ) )}{Z} \vert {i}^{n} 〉 \qquad$$

where E(iⁿ,hⁿ) represents the energy eigenvalues of the Hamiltonian and Z is the partition function and equal to the sum of all possible combinations of states of the system

$$Z = {\sum }_{i , h} exp ( - E ( {i}^{n} , {h}^{n} ) )$$

One can formulate the RBM optimization problem as follows. For a subset S of n states, the constraint on |ψₙ [symbol] to being absolutely maximally entangled is related to the average linear entropy

$$Q ( \vert {ψ}_{n , 2} 〉 ) = \frac{1}{n} {\sum }_{S} \frac{{2}^{n}}{{2}^{n} - 1} ( 1 - t r ( {ρ}_{S}^{2} ) )$$

where ρₛ=tr(|ψₙ [symbol] ) and here the linear entropy has been evaluated for d=2, though it will be appreciated that other values of d may alternatively be used. The average linear entropy may be used as an objective function for optimization. Optimization methods such as artificial bee colony, pattern search, and gradient search may be used to generate the ANN parameters and state functions (ψₙ) that result in maximum entropy.

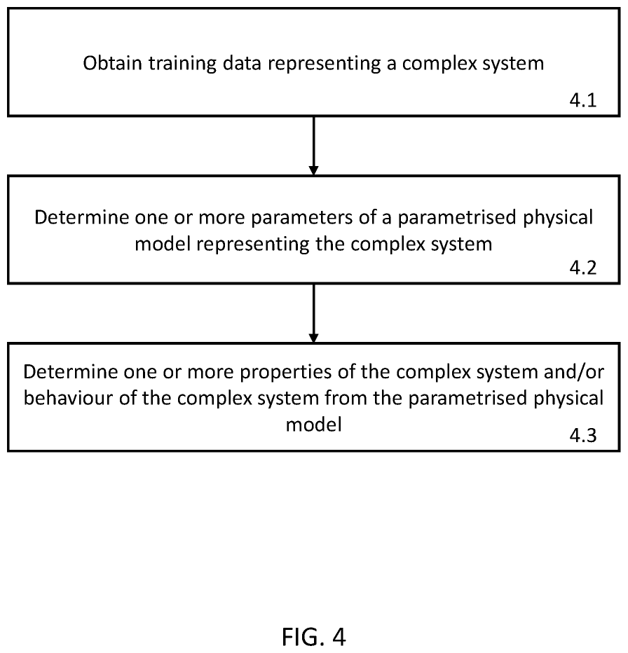

FIG. 4 shows a flow diagram of an example method for modelling a complex system using machine learning. The method may be performed by one or more classical and/or quantum computing devices operating in one or more locations.

At operation 4.1, training data representing the complex system is obtained/received. The training data may be obtained/received from a computer memory.

The training data may be in the form of experimental and/or simulated data about the complex system. For example, it may comprise a plurality of configurations for the system at given “temperatures”, e.g. microstates of the system. The “temperatures” may correspond to thermodynamic temperature in some implementations. In other implementations, the “temperatures” may correspond to some other temperature-like variable of the system that is analogous to thermodynamic temperature.

The complex system may be a physical system, for example a collection of interacting particles or spins, or biological system, for example a system of neurons or amino-acids. The complex system may alternatively be an economic system, a sociological system or an ethical system. In general, the complex system may be a system in which multiple agents/components interact with each other in complex ways (though the source of the interaction itself may be relatively simple).

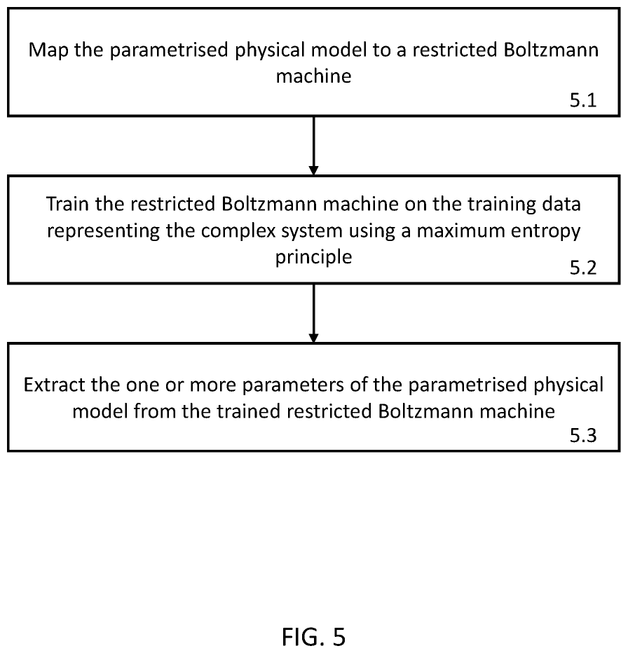

At operation 4.2, one or more parameters of a parametrised physical model representing the complex system are determined using the training data. Examples of this operation are described in further detail below with reference to FIG. 5. In some implementations, a plurality of parameters of the physical model may be determined.

In some implementations, the parametrised physical model may be an Ising model, as described in relation to FIG. 2. In these implementations, the parameters of the parametrised physical model representing the complex system may be the pairwise couplings between spins in the model (e.g. Jᵢⱼ) and/or external field parameters (e.g. hᵢ).

In other implementations, the parametrised physical model may be a Bose-Hubbard model. In these implementations, the parameters of the parametrised physical model representing the complex system may be one or more nearest-neighbour hopping amplitudes (e.g. tᵢⱼ), an on-site interaction strength (U) and/or a chemical potential (μ) of the Bose-Hubbard model.

At operation 4.3, one or more properties of the complex system and/or behaviour of the complex system are predicted/determined from the parametrised physical model. The one or more properties may comprise, or be inferred from, the determined parameters of the model or thermodynamic properties and/or variables of the model that can be derived from the model parameters. Thermodynamic properties and/or variables of the model may be analogous to properties of the complex system.

In implementations where the parametrised physical model is an Ising model, the properties of the complex system may correspond to a magnetisation and/or susceptibility of the Ising model. The magnetisation and/or susceptibility of the Ising model may be determined from the parameters of the parametrised physical model using any technique known in the art.

In implementations where the parametrised physical model is a Bose-Hubbard model, the properties of the complex system may correspond to a critical temperature of the Bose-Hubbard model. The critical temperature may be determined from the parameters of the Bose-Hubbard model using any technique known in the art.

FIG. 5 shows a flow diagram of an example method for determining one or more parameters of a parametrised physical model representing the complex system. The method may be performed by one or more classical and/or quantum computing devices operating in one or more locations.

At operation 5.1, the parametrised physical model is mapped to a restricted Boltzmann machine. Examples of such mappings are described above in relation to the Ising model and Bose-Hubbard model, though it will be appreciated that other model may alternatively be mapped to an RBM. The parameters of the physical model are mapped to the weights and biases (i.e. aₗ, bₖ, Wₗₖ) of the restricted Boltzmann machine.

At operation 5.2, the restricted Boltzmann machine is trained on the training data representing the complex system using a maximum entropy principle. An optimisation procedure, such as an artificial bee colony method, a pattern search method and/or a gradient search optimisation method or the like, may be applied to an objective function to train the restricted Boltzmann machine with the goal of maximising the entropy. The optimisation routine may be applied until a threshold condition is satisfied, such as a threshold number of iterations and/or a convergence criterion.

The objective function may comprise an entropy-based term. The entropy-based term may be a Shannon entropy term. Alternatively, the entropy-based term may comprise an average linear entropy.

At operation 5.3, the one or more parameters of the parametrised physical model are extracted from the trained restricted Boltzmann machine once the training process is complete. The mapping between the parametrised physical model and the parameters of the restricted Boltzmann machine (i.e. the weights and biases of the restricted Boltzmann machine) used in operation 5.1 is inverted to determine the parameters of the parametrised physical model.

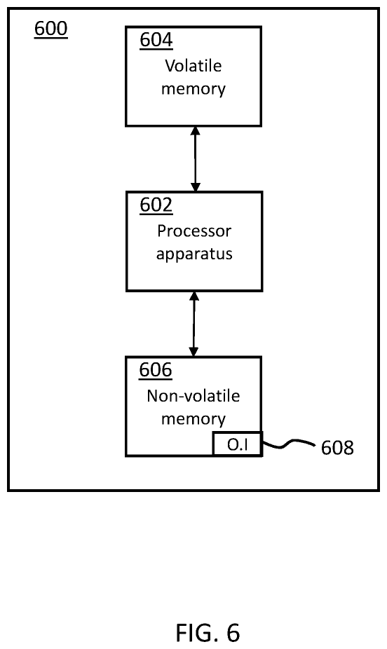

FIG. 6 shows a schematic example of a system/apparatus for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 600 comprises one or more processors 602. The one or more processors control operation of other components of the system/apparatus 600. The one or more processors 602 may, for example, comprise a general-purpose processor. The one or more processors 602 may be a single core device or a multiple core device. The one or more processors 602 may comprise a Central Processing Unit (CPU) or a graphical processing unit (GPU). Alternatively, the one or more processors 602 may comprise specialised processing hardware, for instance a RISC processor or programmable hardware with embedded firmware. Multiple processors may be included.

The system/apparatus comprises a working or volatile memory 604. The one or more processors may access the volatile memory 604 in order to process data and may control the storage of data in memory. The volatile memory 604 may comprise RAM of any type, for example, Static RAM (SRAM), Dynamic RAM (DRAM), or it may comprise Flash memory, such as an SD-Card.

The system/apparatus comprises a non-volatile memory 606. The non-volatile memory 606 stores a set of operation instructions 608 for controlling the operation of the processors 602 in the form of computer readable instructions. The non-volatile memory 606 may be a memory of any kind such as a Read Only Memory (ROM), a Flash memory or a magnetic drive memory.

The one or more processors 602 are configured to execute operating instructions 908 to cause the system/apparatus to perform any of the methods described herein. The operating instructions 608 may comprise code (i.e. drivers) relating to the hardware components of the system/apparatus 600, as well as code relating to the basic operation of the system/apparatus 600. Generally speaking, the one or more processors 602 execute one or more instructions of the operating instructions 608, which are stored permanently or semi-permanently in the non-volatile memory 606, using the volatile memory 604 to temporarily store data generated during execution of said operating instructions 608.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Furthermore, the various example embodiments described herein may be implemented in one aspect by a system/apparatus, such as a computing system/device, comprising one or more processors and a memory. Theme memory may store computer readable instructions that, when executed by the one or more processors, cause the system/apparatus to perform any one or more of the methods described herein.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the example embodiments presented herein.

1. A method for modelling a complex system using machine learning, the method comprising:
obtaining training data representing the complex system;
determining one or more parameters of a parametrised physical model representing the complex system using the training data; and
predicting one or more properties of the complex system and/or behaviour of the complex system from the parametrised physical model,
wherein determining parameters of the parametrised physical model representing the complex system using the training data comprises:
mapping the parametrised physical model to a restricted Boltzmann machine;
training the restricted Boltzmann machine on the training data representing the complex system using a maximum entropy principle; and
extracting the one or more parameters of the parametrised physical model from the trained restricted Boltzmann machine.

2. The method of claim 1, wherein training the restricted Boltzmann machine on the training data representing the complex system comprises applying an optimisation procedure to an objective function comprising an entropy-based term.

3. The method of claim 2, wherein the entropy-based term comprises a Shannon entropy.

4. The method of claim 2, wherein the entropy-based term comprises an average linear entropy, and wherein the optimisation procedure comprises the use of an artificial bee colony method, a pattern search method and/or a gradient search optimisation method.

5. The method of claim 1, wherein the parametrised physical model is the Ising model, and wherein the parameters comprise one or more pairwise couplings and/or one or more external field parameters.

6. The method of claim 5, wherein determining one or more properties of the complex system from the parametrised model comprises determining a magnetisation and/or susceptibility of the Ising model.

7. The method of claim 1, wherein the parametrised physical model is the Bose-Hubbard model, and wherein the parameters comprise one or more nearest-neighbour hopping amplitudes, an on-site interaction strength and/or a chemical potential.

8. The method of claim 7, wherein determining one or more properties of the complex system from the parametrised model comprises determining a critical temperature from the Bose-Hubbard model.

9. The method of claim 1, wherein the complex system comprises a physical or biological system.

10. A non-transitory, computer readable medium containing instructions that, when executed by a computer, cause the computer to perform a method for modelling a complex system using machine learning, the method comprising:
obtaining training data representing the complex system;
determining one or more parameters of a parametrised physical model representing the complex system using the training data; and
predicting one or more properties of the complex system and/or behaviour of the complex system from the parametrised physical model,
wherein determining parameters of the parametrised physical model representing the complex system using the training data comprises:
mapping the parametrised physical model to a restricted Boltzmann machine;
training the restricted Boltzmann machine on the training data representing the complex system using a maximum entropy principle; and
extracting the one or more parameters of the parametrised physical model from the trained restricted Boltzmann machine.

11. The computer readable medium of claim 10, wherein training the restricted Boltzmann machine on the training data representing the complex system comprises applying an optimisation procedure to an objective function comprising an entropy-based term.

12. The computer readable medium of claim 11, wherein the entropy-based term comprises a Shannon entropy.

13. The computer readable medium of claim 11, wherein the entropy-based term comprises an average linear entropy, and wherein the optimisation procedure comprises the use of an artificial bee colony method, a pattern search method and/or a gradient search optimisation method.

14. The computer readable medium of claim 10, wherein the parametrised physical model is the Ising model, and wherein the parameters comprise one or more pairwise couplings and/or one or more external field parameters.

15. The computer readable medium of claim 14, wherein determining one or more properties of the complex system from the parametrised model comprises determining a magnetisation and/or susceptibility of the Ising model.

16. The computer readable medium of claim 10, wherein the parametrised physical model is the Bose-Hubbard model, and wherein the parameters comprise one or more nearest-neighbour hopping amplitudes, an on-site interaction strength and/or a chemical potential.

17. The computer readable medium of claim 16, wherein determining one or more properties of the complex system from the parametrised model comprises determining a critical temperature of the Bose-Hubbard model.

18. The computer readable medium of claim 10, wherein the complex system comprises a physical or biological system.

19. A system comprising one or more processors and a memory, the memory containing computer-readable instructions that, when executed by the one or more processors, causes the system to perform a method for modelling a complex system using machine learning, the method comprising:
obtaining training data representing the complex system;
determining one or more parameters of a parametrised physical model representing the complex system using the training data; and
predicting one or more properties of the complex system and/or behaviour of the complex system from the parametrised physical model,
wherein determining parameters of the parametrised physical model representing the complex system using the training data comprises:
mapping the parametrised physical model to a restricted Boltzmann machine;
training the restricted Boltzmann machine on the training data representing the complex system using a maximum entropy principle; and
extracting the one or more parameters of the parametrised physical model from the trained restricted Boltzmann machine.

20. The computer readable medium of claim 10, wherein training the restricted Boltzmann machine on the training data representing the complex system comprises applying an optimisation procedure to an objective function comprising an entropy-based term.
